(19) United States
(12) Patent Application Publication
(10) Pub. No.: US 2011/0174159 A1
(43) Pub. Date: Jul. 21, 2011

(54) PUMP SUCTION GAS SEPARATOR

(75) Inventors: Stephen Swantner, Plum, PA (US); Matthew Swartz, Jeannette, PA (US)

(73) Assignee: Westinghouse Electric Company LLC, Cranberry Township, PA (US)

(21) Appl. No.: 12/828,602

(22) Filed: Jul. 1, 2010

Related U.S. Application Data
(60) Provisional application No. 61/295,191, filed on Jan. 15, 2010.
(60) Provisional application No. 61/296,503, filed on Jan. 20, 2010.

(51) Int. Cl. B01D 19/00; B23P 11/00

(52) U.S. Cl. 96/194; 29/428

(57) ABSTRACT

A gas separator on pipe structured to transport a liquid is provided. The gas separator includes a section of piping, located upstream of a pump, having an increased diameter which is in fluid communication with an overhead pocket. Fluid flow in the portion of the pipe having an increased diameter is at a slower rate than other portions of the pipe. The slower fluid speed allows entrained gasses to stratify and float to the top of the pipe whereupon the gas will flow into the pocket. Thus, the fluid downstream from the gas separator has a reduced amount of gas in the liquid flow.

### CROSS REFERENCE TO RELATED APPLICATIONS

This application is related to and claims priority from provisional application Ser. No. 61/295,191, filed Jan. 15, 2010, entitled PUMP SUCTION GAS SEPARATOR and Ser. No. 61/296,503, filed Jan. 20, 2010, entitled PUMP SUCTION GAS SEPARATOR.

### BACKGROUND OF THE INVENTION

1. Field of the Invention

This device is installed in the suction of a pump and removes any entrained gases from the liquid without significant additional pressure losses. This device is intended to be used in the suction of safety related emergency core cooling system (ECCS), decay heat removal (DHR) and containment spray system (CSS) pumps in light water reactors.

This device is fully effective in removing during dynamic post-accident events and ensures the pump remains fully functional to perform its post accident conditions. This is the novel feature of this device. All currently known gas removal systems rely on venting the gas prior to the post accident event. Other novel features include pipe inclination and expansion upstream of the separator tee.

2. Description of the Prior Art

Gas intrusion in ECCS, DHR and CSS piping systems has been an ongoing issue at power plants. These events have rendered pumps and systems inoperable and incapable of performing their safety functions. The inability of utilities to effectively preclude these events resulted in the issuance of Generic Letter (GL) 2008-01 in January, 2008 by the US NRC. Utilities have heretofore relied on a combination of ultrasonic monitoring (UM) at specific locations to detect gas and venting (through vent valves) to detect and remove gas. These current approaches do not work if the gas collects at a location that is not monitored by UM or at a location at which a vent valve does not exist.

As part of their approach in addressing GL 2008-01, PG&E installed void headers at specific locations in the Diablo Canyon units. These devices are similar to the proposed invention and automatically vent gases from certain locations during normal operation under static conditions (with little or no flow rate in the system). The void header device does not utilize a main suction path piping modification and increased pipe diameter to reduce flow velocity and allow stratification, unlike the proposed invention. The proposed invention is capable of automatically venting the gas under dynamic (full system flow) conditions as it enters the pump inlet piping. This provides a major benefit in safety as a substantial portion of gas is removed prior to entering the pump irrespective of where gas collected in the plant.

### SUMMARY OF THE INVENTION

The disclosed concept provides for a gas separator on pipe structured to transport a liquid. The gas separator includes a section of piping, located upstream of the pump, having an increased diameter which is in fluid communication with an overhead pocket. Fluid flow in the portion of the pipe having an increased diameter is at a slower rate than other portions of the pipe. The slower fluid speed allows for entrained gasses to stratify and float to the top of the pipe whereupon the gas will flow into the pocket. Thus, the fluid downstream from the gas separator has a reduced amount of gas in the liquid flow.

More specifically, the gas separator includes a section of horizontal piping upstream of the pump that is replaced with larger diameter piping. This is accomplished by removing a section of pipe and installing an expander, a length of larger-diameter pipe, and a reducer to return to the diameter of the pump inlet nozzle. The purpose of the larger pipe diameter is to reduce the fluid velocity to a level where any entrained gas will stratify under the effects of buoyancy to the top of the pipe. Generally, the speed of the fluid is reduced to about five feet per second.

The length of larger diameter piping has an inlet port and an outlet port as well as contains a “T” or “Y” connection with a branch port aligned vertically upwards. The thru ports and the branch ports are, preferably, the same diameter as the installed piece of pipe, however the port may be smaller or larger so long as the port is not insignificantly small. The purpose of the vertical “T” or “Y” branch port is to automatically vent the gas which has stratified to the top of the pipe.

Another length of horizontal pipe may be connected to the top of the vertical “T” branch port. The diameter of this pipe may be the same as the diameter of the replaced piping. The purpose of this section of pipe is to store the gas which is vented from the flow stream. A vent valve is installed on the top horizontal pipe and is structured to vent the trapped gas.

The required diameter of the replacement piping and the location of the “T” in the pipe can be optimized for the particular application. Further optimization may be obtained using variations in upstream piping components (such as vertically upwards or downwards approaching flow and concentric or eccentric expanders) and/or by inclining the device at various angles.

A test program is being conducted by Westinghouse System and Equipment Engineering to define and optimize the required diameter of the replacement piping and the location of the “T” in the pipe. The test program is also investigating the impact of possible variations in upstream piping components (such as vertically upwards or downwards approaching flow and concentric or eccentric expanders) in performance of the device. It is expected that the performance of this device will be improved if installed downstream of a vertical to horizontal elbow.

The proposed invention has the following unique features which result in its novelty and benefit.

The device is totally passive and relies on no power operated equipment or actuation signals. This improves the reliability of the invention.

The device results in little or no increased pressure drop in the pump inlet piping. This is important to ensure that adequate net positive suction head (NPSH) is available to the pump.

The device is fully effective under dynamic conditions. This is the critical feature of the invention since it ensures that any gas transported to the pump inlet will be removed prior to entering the pump irrespective of the source of the gas.

The device is made of simple off-the-shelf components. This facilitates fabrication of the device.

The design basis of the device will be based on a very thorough set of experimental data which is currently being collected.

The device may include an expansion in the vertical pipe or horizontal pipe entering the device.

The device may be inclined, which will promote flow stratification.

### BRIEF DESCRIPTION OF THE DRAWINGS

A further understanding of the invention can be gained from the following description of the preferred embodiments when read in conjunction with the accompanying drawings in which:

FIG. 1 is a cross-sectional side view of one embodiment of the gas separator;

FIG. 2 is an side view of the gas separator shown in FIG. 1;

FIG. 3 is an side view of another embodiment of the gas separator; and

FIG. 4 is a flow chart of the method for installing a gas separator.

### DESCRIPTION OF THE PREFERRED EMBODIMENTS

As is known, pipes generally have a circular cross-sectional area. The following discussion shall assume a pipe having a circular cross-sectional area but the disclosed concept is not so limited. Accordingly, any words used herein that relate to a pipe having a circular cross-sectional shall be interpreted broadly so as to include pipes with other cross-sectional shapes. For example, a “radius” shall be interpreted broadly to include the major and minor radii of a pipe having an elliptical cross-sectional area as well as the length, width, or diagonal of a square/rectangular pipe.

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body.

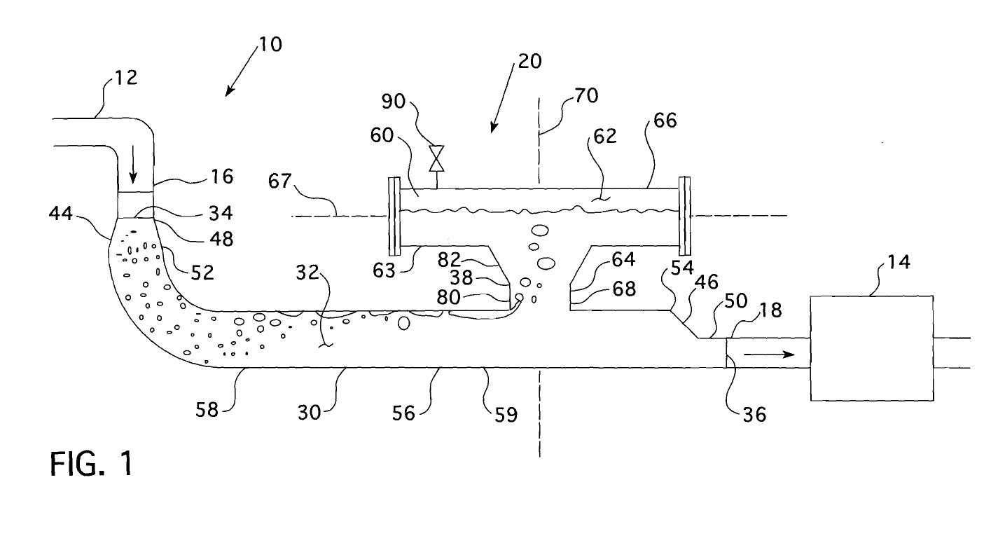

As shown in FIG. 1, a piping system 10 includes at least one liquid transport pipe 12 structured to transport a liquid. That is, the at least one liquid transport pipe 12 is structured to have a liquid flow therethrough. As is known, liquid traveling through a piping system 10 may come to have gas entrained in, i.e. mixed into, the liquid. Further, liquid being transported in a piping system 10 may be moving at relatively fast and/or be a turbulent flow. Entrained gas may be separated into many small bubbles that lack a sufficient buoyancy to overcome the turbulence and/or flow speed and therefore cannot rise within the liquid flow. Such entrained gas may cause damage or inefficiencies in a suction pump 14 located downstream of the at least one liquid transport pipe 12.

A gas separator 20 structured to remove a substantial portion of the gas is incorporated in the at least one liquid transport pipe 12 at a location upstream of the pump 14. That is, the at least one liquid transport pipe 12 is bifurcated so that it has an upstream outlet 16 and a downstream inlet 18. The gas separator 20 is disposed between, and sealingly coupled to, the pipe upstream outlet 16 and downstream inlet 18.

The gas separator 20 includes a first body 30 and a second body 60. The first body 30 defines an enclosed passage 32, a liquid inlet 34, a liquid outlet 36, and an ascendant gas outlet 38. The first body liquid inlet 34 is sealingly coupled to the liquid transport pipe upstream outlet 16, and, the first body liquid outlet 36 is sealingly coupled to the liquid transport pipe downstream inlet 18. The first body 30 is in fluid communication with the liquid transport pipe upstream outlet 16, and, the liquid transport pipe downstream inlet 18. Thus, a fluid may pass from the liquid transport pipe 12 into the first body 30. Further, the fluid may exit the first body 30 via the first body liquid outlet 36 and return to the liquid transport pipe 12.

Generally, liquid must be flowing at a speed of between about zero to seven feet per second, and more preferably five feet per second, for a significant portion of the entrained gas to coalesce and/or float to the top of the liquid. Thus, for example, if the liquid transport pipe 12 has a radius of three inches (3.0 in.) and the liquid is flowing at a speed of about ten feet per second, the gas separator first body 30 preferably has a diameter of about four and a quarter inches (4.25 in). A gas separator first body 30 with this radius has about twice the area as the liquid transport pipe 12, thus the speed of the liquid flow is reduced by about half, i.e. five feet per second.

The enclosed passage 32 has an inner cross-sectional area greater than the liquid transport pipe 12. While the example above provided for a first body 30 having a cross-sectional area about twice the liquid transport pipe 12, the first body 30 inner cross-sectional area is, preferably, about 80% larger than the liquid transport pipe 12 inner cross-sectional area. This is a general estimation for the size of the first body 30, however, the size of the first body 30 is related to the speed of the liquid in the liquid transport pipe 12 and the cross-sectional area of the liquid transport pipe 12. The size of the first body 30, i.e. the cross-sectional area of the first body 30, is structured to reduce the speed of the liquid flow therein to between about zero feet per second to seven feet per second, and more preferably five feet per second. Further, and as described below, when installed, the gas separator 20 is oriented so that the ascendant gas outlet 38 is disposed on the upper side of the first body 30.

Because the first body 30 inner cross-sectional area is larger than the liquid transport pipe 12, the speed of the liquid as it flows through the first body 30 is slower than the speed of the liquid as it flows through the liquid transport pipe 12. As the flow speed of the liquid is reduced, a substantial portion of the gas entrained in the liquid will stratify, i.e. the gas bubbles float toward the top of the first body 30. During stratification of the entrained gas, a number of tiny bubbles coalesce into either a single larger bubble or a matrix of larger bubbles, the larger bubble(s) tend to have a sufficient buoyancy to overcome the turbulence and/or flow speed. Thus, a substantial portion of gas ascends upwardly in the first body 30. In this configuration, and as the liquid flow moves the larger bubbles, hereinafter the gas, downstream, the gas moves across the ascendant gas outlet 38 located along the upper side of the first body 30. The gas then passes upwardly through the ascendant gas outlet 38 and is stored in the second body 60 as described more completely below. Thus, the liquid downstream of the ascendant gas outlet 38 has substantially less entrained gas than the liquid upstream of the ascendant gas outlet 38.

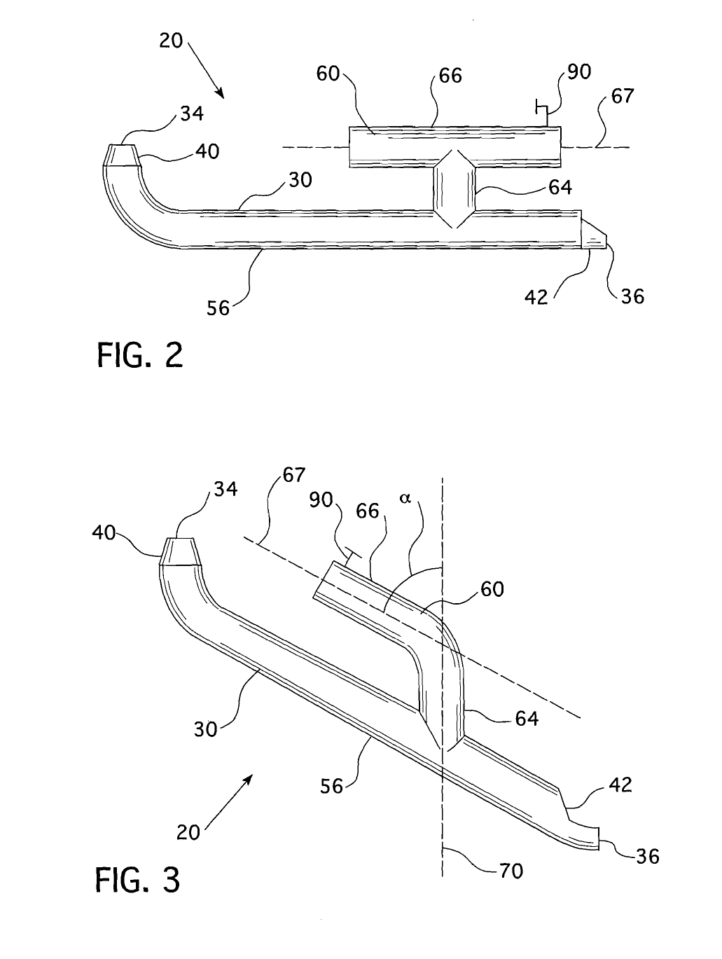

As shown in FIG. 2, the first body 30 may be a unitary construct wherein the liquid inlet 34 is a funnel 40 having a narrow end sized to correspond to the liquid transport pipe upstream outlet 16, and, the liquid outlet 36 is a funnel 42 having a narrow end sized to correspond to the liquid transport pipe downstream inlet 18. Alternatively, as shown in FIG. 1, the first body 30 may include a separate expander 44 and reducer 46. Each of the expander 44 and reducer 46 has a pipe end 48, 50 sized to correspond to the liquid transport pipe 12 and more specifically to the liquid transport pipe upstream outlet 16 or liquid transport pipe downstream inlet 18, and, a gas separator end 52, 54 sized to correspond to the diameter of the first body 30.

The first body 30 is, preferably, an elongated, cylindrical body having a transition portion 56 disposed between the liquid inlet 34 and the ascendant gas outlet 38. The transition portion 56 is the portion of the first body 30 wherein the entrained gas coalesce into either a single larger bubble or a matrix of larger bubbles. The length of the transition portion 56 is preferably between about 2.0 feet and 20.0 feet, and more preferably about 10.0 feet. Depending upon the initial flow speed of the liquid, and assuming the liquid flow speed is reduced to about five feet per second in the first body 30, this length should provide sufficient time for a significant portion of the entrained gas to stratify. The transition portion 56 has a first, upstream end 58 and a second, downstream end 59. The transition portion 56 may be inclined with the first, upstream end 58 being at a higher elevation. That is, the flow of liquid through the first body travels downwardly at an angle. The transition portion 56 has an angle of inclination of between about 0 and 45 degrees from horizontal and more preferably about 0 degrees from horizontal.

The second body 60 defines an enclosed pocket 62. The second body 60 is coupled to the first body 30 and the pocket 62 is in fluid communication with the ascendant gas outlet 38. That is, the second body 60 includes a vertical conduit 64 and a gas storage vessel 66. While the second body 60 may have any shape, for ease of construction, as well as other reasons, the second body 60 is, and more specifically the components (vertical conduit 64 and gas storage vessel 66) are, preferably the same shape and size of the liquid transport pipe 12. That is, the second body 60 is preferably a section of hollow circular piping 63. The vertical conduit 64 defines a passage 68 and having an axis 70. The gas storage vessel 66 is a hollow body structured to store a fluid and primarily defines the pocket 62. The vertical conduit 64 is sealing coupled to, or formed as a unitary body with, the first body 30. The vertical conduit 64 is disposed about the ascendant gas outlet 38. That is, there is a path of fluid communication between the ascendant gas outlet 38 and the vertical conduit passage 68. The vertical conduit 64, or more specifically the vertical conduit passage 68, is also in fluid communication with the pocket 62 defined by the gas storage vessel 66. Thus, there is a path of fluid communication between the ascendant gas outlet 38 and the pocket 62. It is noted that the vertical conduit 64, and more specifically the vertical conduit axis 70, extends generally vertically regardless of the inclination of the first body 30

The vertical conduit 64 may have a generally constant cross-sectional area, i.e. the hollow circular piping 63 forming the vertical conduit 64 may have a generally consistent radius over the length of the vertical conduit axis 70. Alternatively, the vertical conduit 64 may be tapered with the smaller cross-sectional area disposed about the ascendant gas outlet 38 (not shown). As another alternative, the vertical conduit 64 may have a localized expansion. That is, the second body vertical conduit 64 has a first portion 80 and a second portion 82 with the first portion 80 being disposed adjacent the first body 30 and second portion 82 being disposed adjacent the gas storage vessel 66. The vertical conduit first portion 80 has a first cross-sectional area and the vertical conduit second portion 82 has a second cross-sectional area which is larger than the vertical conduit first portion 80 cross-sectional area. At the interface of the vertical conduit first portion 80 and second portion 82 is a flange or tapered portion.

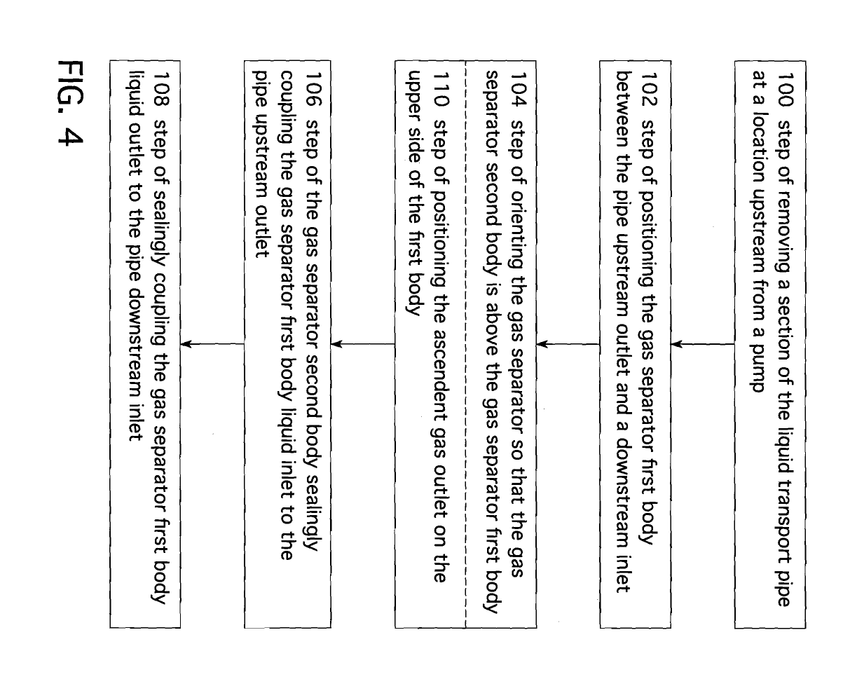

The gas storage vessel 66 may be, but is preferably not, a simple aligned, continuation of the vertical conduit 64. That is, as shown in FIG. 3, the gas storage vessel 66 is preferably an elongated body having a longitudinal axis 67 that is angled relative to a vertical axis. Thus, the gas storage vessel axis 67 is, preferably, disposed at an angle relative to the second body vertical conduit axis 70. Preferably, the gas storage vessel axis 67 extends between about 0 to 45 degrees from vertical and more preferably about 0 degrees from vertical, angle α in FIG. 3. That is, as shown in FIGS. 1-2, among the many shapes the second body 60 may be is a “T” shape with the gas storage vessel 66 being the horizontal portion of the “T” and the vertical conduit 64 being the vertical portion of the “T.” Alternately, as shown in FIG. 3 and in conjunction with an inclined first body 30, the second body 60 may also be generally “L” shaped with the lower portion of the “L” being the vertical conduit 64 and the upper portion of the “L” being the gas storage vessel 66.

In use, the gas separator 20 is, preferably, substantially filled with liquid. Over time, the gas entrained in the liquid flowing through the piping system 10 enters the gas separator 20 at the first body liquid inlet 34. Because the first body 30 has a greater cross-sectional area that the liquid transport pipe 12, the speed of the liquid flow in the first body 30 is slower than in the liquid transport pipe 12. As described above, the entrained gas coalesces into either a single larger bubble or a matrix of larger bubbles in the transition portion 56 of the first body 30. The bubble(s) moves to the upper side of the first body 30. When the gas/bubble moves downstream to the ascendant gas outlet 38, the gas passes through the ascendant gas outlet 38 and rises into the vertical conduit 64 and eventually the gas storage vessel 66. The gas rises naturally due to buoyancy and no mechanical/electrical parts are required to direct the gas into the gas storage vessel 66. The gas that enters the gas storage vessel 66 displaces a portion of the liquid stored therein. Eventually, however, the gas storage vessel 66 will fill with gas. Accordingly, the gas storage vessel 66 also includes an vent valve 90 structured to exhaust gas from the pocket 62. Preferably, the vent valve 90 is actuated prior to the second body 60 becoming substantially empty of liquid and always before the liquid level in the second body 60 drops to a point adjacent the ascendant gas outlet 38 where it may become entrained again with the liquid flowing through the first body 30.

As noted above, one advantage of the disclosed gas separator 20 is that it operates with no mechanical/electrical parts. Another advantage is that the gas separator 20 may be easily installed as described below. That is, the method of installing the gas separator 20 disclosed above includes the steps of removing 100 a section of the liquid transport pipe at a location upstream from a pump, the removal creating an upstream outlet and a downstream inlet in the pipe, positioning 102 the gas separator first body between the pipe upstream outlet and a downstream inlet, orienting 104 the gas separator 20 so that the gas separator second body 60 is above the gas separator first body 30, sealingly coupling 106 the gas separator first body liquid inlet 34 to the pipe upstream outlet, and sealingly coupling 108 the gas separator first body liquid outlet 36 to the pipe downstream inlet 18. It is noted that the step of orienting 104 the gas separator 20 so that the gas separator second body 60 is above the gas separator first body 30 includes the step of positioning 110 the ascendant gas outlet 38 on the upper side of the first body 30.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention, which is to be given the full breadth of the appended claims and any and all equivalents thereof.

What is claimed is:

1. A gas separator for a bifurcated liquid transport pipe structured to transport a liquid, said pipe having a generally cylindrical inner cross-sectional area with a diameter, an upstream outlet and a downstream inlet, said liquid having gas entrained therein, said gas separator comprising:
a first body defining an enclosed passage, a liquid inlet, a liquid outlet, and an ascendant gas outlet, said enclosed passage having an inner cross-sectional area greater than said liquid transport pipe;
a second body defining an enclosed pocket, said second body coupled to said first body, said pocket in fluid communication with said ascendant gas outlet;
said liquid inlet coupled to, and in fluid communication with, said transport pipe upstream outlet;
said liquid outlet coupled to, and in fluid communication with, said transport pipe downstream inlet;
wherein the speed of the liquid flow through said first body is slower than the flow through said liquid transport pipe; and
wherein a substantial portion of gas entrained in the liquid stratifies while said liquid is in said first body, and wherein said substantial portion of gas ascends upwardly in said first body, through said ascendant gas outlet, and into said pocket.

2. The gas separator of claim 1 wherein said first body is elongated, having a transition portion disposed between said liquid inlet and said ascendant gas outlet.

3. The gas separator of claim 2 wherein:
said first body transition portion has an upstream end and a downstream end; and
said first body transition portion is inclined with said upstream end being higher than said downstream end.

4. The gas separator of claim 3 wherein:
said second body includes a vertical conduit having an axis, said vertical conduit in fluid communication with said ascendant gas outlet and with said pocket; and
said second body vertical conduit axis extending generally vertically.

5. The gas separator of claim 4 wherein said second body vertical conduit having a cross-sectional area that is at least about the same as said liquid transport pipe.

6. The gas separator of claim 5 wherein:
said second body vertical conduit has a first portion with a first cross-sectional area and a second portion with a second cross-sectional area;
said second body vertical conduit second portion having a larger cross-sectional area than said vertical conduit first portion cross-sectional area.

7. The gas separator of claim 6 wherein:
said second body includes an elongated gas storage vessel defining said pocket; and
said gas storage vessel longitudinal axis disposed at an angle relative to said second body vertical conduit axis.

8. The gas separator of claim 1 wherein said second body includes at least one vent valve structured to exhaust gas from said pocket.

9. The gas separator of claim 1 wherein said first body inner cross-sectional area is about 80% larger than said liquid transport pipe inner cross-sectional area.

10. A piping system for transporting a liquid, said liquid having a gas entrained therein, said liquid transport system comprising:
a bifurcated liquid transport pipe structured to transport a liquid, said pipe having a generally cylindrical cross-sectional area with a diameter, an upstream outlet and a downstream inlet;
a gas separator disposed between, and in fluid communication with both, said liquid transport pipe upstream outlet and a downstream inlet;
a suction pump, said pump coupled to, and in fluid communication with, said liquid transport pipe downstream inlet;
said gas separator including a first body and a second body;
said first body defining an enclosed passage, a liquid inlet, a liquid outlet, and an ascendant gas outlet, said enclosed passage having a cross-sectional area greater than said liquid transport pipe;
said second body defining an enclosed pocket, said second body coupled to said first body, said pocket in fluid communication with said ascendant outlet;
said liquid inlet coupled to, and in fluid communication with, said transport pipe upstream outlet;
said liquid outlet coupled to, and in fluid communication with, said transport pipe downstream inlet;
wherein the speed of the liquid flow through said first body is slower than the flow through said liquid transport pipe; and
wherein a substantial portion of gas entrained in the liquid stratifies while said liquid is in said first body, and wherein said substantial portion of gas ascends upwardly in said first body, through said ascendant gas outlet, and into said pocket.

11. The piping system of claim 10 wherein said first body is elongated, having a transition portion disposed between said liquid inlet and said ascendant gas outlet.

12. The piping system of claim 11 wherein:
said first body transition portion has an upstream end and a downstream end; and
said first body transition portion is inclined with said upstream end being higher than said downstream end.

13. The piping system of claim 12 wherein:
said second body includes a vertical conduit having an axis, said vertical conduit in fluid communication with said ascendant gas outlet and with said pocket; and
said second body vertical conduit axis extending generally vertically.

14. The piping system of claim 13 wherein said second body vertical conduit having a cross-sectional area that is at least about the same as said first body cross-sectional area.

15. The piping system of claim 14 wherein:
said second body vertical conduit has a first portion and a second portion;
said second body vertical conduit second portion having a larger cross-sectional area than said first body cross-sectional area.

16. The piping system of claim 15 wherein:
said second body includes an elongated gas storage vessel defining said pocket; and
said gas storage vessel longitudinal axis disposed at an angle relative to said second body vertical conduit axis.

17. The piping system of claim 10 wherein said second body includes at least one vent valve structured to exhaust gas from said pocket.

18. The piping system of claim 10 wherein said first body pipe inner cross-sectional is about 80% larger than said first body passage inner cross-sectional area.

19. A method of installing a gas separator in a piping system having a liquid transport pipe, said pipe having a generally cylindrical cross-sectional area with a diameter, said gas separator having a first body and a second body, said first body defining an enclosed passage, a liquid inlet, a liquid outlet, and an ascendant gas outlet, said enclosed passage having a cross-sectional area greater than said liquid transport pipe, said second body defining an enclosed pocket, said second body coupled to said first body, said pocket in fluid communication with said ascendant outlet, said method comprising the steps of:
removing a section of said liquid transport pipe at a location upstream from a pump, the removal creating an upstream outlet and a downstream inlet in said pipe;
positioning said gas separator first body between said pipe upstream outlet and a downstream inlet;
orienting said gas separator so that said gas separator second body is above said gas separator first body;
sealingly coupling said gas separator first body liquid inlet to said pipe upstream outlet; and
sealingly coupling said gas separator first body liquid outlet to said pipe downstream inlet.

20. The method of claim 19 wherein said step of orienting said gas separator so that said gas separator second body is above said gas separator first body includes the step of positioning said ascendant gas outlet on the upper side of said first body.
